(19) United States
(12) Patent Application Publication
(10) Pub. No.: US 2015/0015850 A1
(43) Pub. Date: Jan. 15, 2015

(54) LASER LIGHT SOURCE MODULE FOR PROJECTION SYSTEM

(71) Applicant: DELTA ELECTRONICS, INC., Taoyuan Hsien (TW)

(72) Inventors: Chun-Hsien Cho, Taoyuan Hsien (TW); Bor Wang, Taoyuan Hsien (TW)

(73) Assignee: DELTA ELECTRONICS, INC., Taoyuan Hsien (TW)

(21) Appl. No.: 14/161,399

(22) Filed: Jan. 22, 2014

(30) Foreign Application Priority Data
Jul. 12, 2013 (TW) 102125073

(51) Int. Cl. H01S 3/13; G03B 21/14

(52) U.S. Cl. CPC H01S 3/1305; G03B 21/142
USPC 353/31; 362/84

(57) ABSTRACT

A projection system includes a laser light source module, at least one display module, and a projection lens. The laser light source module includes at least one light source, at least one wavelength conversion element, at least one light detecting unit, and a controller. The laser light source emits a first light beam with a first wavelength. The wavelength conversion element is used for converting the first light beam into a light beam with a wavelength different from the first wavelength. After an optical energy of the light beam outputted from the wavelength conversion element and higher than a systematic etendue is detected by an optical sensor of the laser light source module, at least one of a brightness and a light color of the laser light source module is adjusted or compensated by the controller according to the detecting result.

### FIELD OF THE INVENTION

The present invention relates to a laser light source module for a projection system, and more particularly to a laser light source module for maintaining stability of the resulting output brightness or color of the projection system. The present invention also relates to a projection system employing the laser light source module.

### BACKGROUND OF THE INVENTION

The light sources used in most projection systems are for example high pressure mercury lamps (UHP lamps) or xenon lamps. However, since these light sources have short life spans and usually generate undesired ultraviolet light beams or infrared light beams, the applications of the UHP lamps or the xenon lamps on the projection systems are restricted. For solving the above drawbacks, light emitting diodes (LED) gradually become the light sources of the projection systems in order to prolong the life spans and avoid generation of undesired ultraviolet light beams or infrared light beams. Due to the limitations of projection systematic etendue and LED light source lumen output, the light utilization efficiency and brightness performance of LED light source are not very high. Consequently, the applications of the LED light sources on the projection systems are also restricted.

For solving the drawbacks of the LED light sources, a light source module with a laser light source and a wavelength conversion element is used in the projection system. The laser light source is advantageous for its high stability and long life span. Moreover, the laser light beam has smaller etendue and higher light utilization efficiency. However, after the laser light source and the wavelength conversion element have been used for a long time, the efficiency of the laser light source and the efficiency of the wavelength conversion element may slightly attenuate. Since the efficiency attenuation of the laser light source and the wavelength conversion element may adversely affect the resulting output brightness or color of the projection system, it is necessary to compensate and adjust the brightness or color of the laser light module in real time.

Therefore, there is a need of providing an improved laser light source module and an improved projection system in order to avoid the above drawbacks.

### SUMMARY OF THE INVENTION

The present invention provides a projection system and a laser light source module of the projection system. The laser light source module includes at least one laser light source, at least one wavelength conversion element, and at least one light detecting unit. The laser light source is used for emitting a first light beam with a first wavelength. The wavelength conversion element for converting the first light beam into at least one light beam with a wavelength different from the first wavelength. The light detecting unit is located beside the wavelength conversion element. After an optical energy of the light beam which is outputted from the wavelength conversion element and higher than the systematic etendue of the projection system is detected by the light detecting unit, the output power of the laser light source is correspondingly controlled according to the detecting result. Consequently, at least one of a brightness and a light color of the projection system is adjusted or compensated.

The present invention also provides a laser light source module of a projection system. The laser light source module includes a light detecting unit for detecting an optical energy at a region with an etendue higher than the systematic etendue of the projection system. The light detecting unit is not arranged in the systematic optical path. Consequently, the systematic optical path is not influenced by the light detecting unit. The light detecting unit is used to detect the attenuation of the laser light source and the wavelength conversion element in real time, thereby adjusting at least one of a brightness and a light color of a laser light source of the laser light source module.

In accordance with an aspect of the present invention, the projection system includes a laser light source module, at least one display module, and a projection lens. The laser light source module includes at least one laser light source, at least one wavelength conversion element, at least one light detecting unit, and a controller. The laser light source emits a first light beam with a first wavelength. The wavelength conversion element is used for converting the first light beam into at least one light beam with a wavelength different from the first wavelength. The light detecting unit includes at least one optical sensor. The controller is electrically connected with the light detecting unit. The display module is used for receiving the light beam from the laser light source module, and outputting a modulated light beam. The projection lens is used for receiving the modulated light beam and projecting an image beam. After an optical energy of the light beam outputted from the wavelength conversion element and higher than a systematic etendue is detected by the optical sensor of the laser light source module, at least one of a brightness and a light color of the laser light source module is adjusted or compensated by the controller according to the detecting result.

In accordance with another aspect of the present invention, the laser light source module for a projection system includes at least one laser light source, at least one wavelength conversion element, at least one light detecting unit, and a controller. The laser light source emits a first light beam with a first wavelength. The wavelength conversion element is used for converting the first light beam into at least one light beam with a wavelength different from the first wavelength. The light detecting unit includes an optical sensor. The controller is electrically connected with the light detecting unit. After an optical energy of the light beam outputted from the wavelength conversion element and higher than a systematic etendue is detected by the optical sensor, at least one of a brightness and a light color of the laser light source is adjusted or compensated by the controller according to the detecting result.

The above contents of the present invention will become more readily apparent to those ordinarily skilled in the art after reviewing the following detailed description and accompanying drawings, in which:

### BRIEF DESCRIPTION OF THE DRAWINGS

FIG. 1 schematically illustrates the architecture of a projection system according to a first embodiment of the present invention;

FIG. 2A schematically illustrates an exemplary laser light source module used in the transmission-type projection system according to the first embodiment of the present invention;

FIG. 2B schematically illustrates another exemplary laser light source module used in the transmission-type projection system of FIG. 2A;

FIG. 3A schematically illustrates an exemplary laser light source module used in a reflective-type projection system according to a second embodiment of the present invention;

FIG. 3B schematically illustrates another exemplary laser light source module used in a reflective-type projection system of FIG. 3A;

FIG. 4 schematically illustrates an exemplary laser light source module used in a single-chip projection system according to a third embodiment of the present invention; and

FIG. 5 schematically illustrates an exemplary laser light source module used in a three-chip projection system according to a fourth embodiment of the present invention.

### DETAILED DESCRIPTION OF THE PREFERRED EMBODIMENT

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

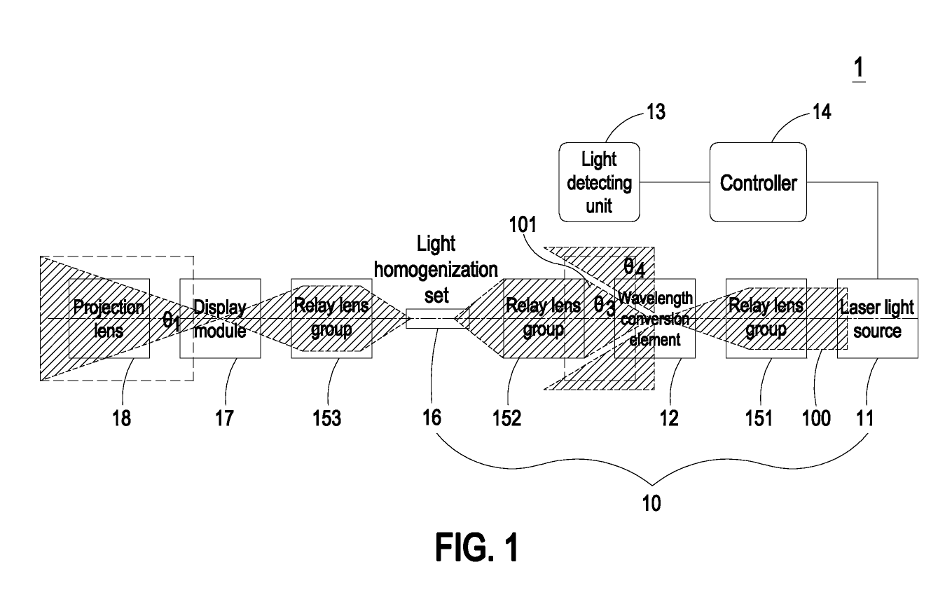

FIG. 1 schematically illustrates the architecture of a projection system according to a first embodiment of the present invention. As shown in FIG. 1, the projection system 1 comprises a laser light source module 10, a display module 17, and a projection lens 18. The laser light source module 10 comprises at least one laser light source 11, at least one wavelength conversion element 12, at least one light detecting unit 13, a controller 14, a plurality of relay lens groups (for example two relay lens groups 151, 152), and a light homogenization set 16. In this embodiment, the laser light source module 10 comprises one laser light source 11. Alternatively, in some other embodiments, the laser light source module 10 may comprise a plurality of laser light sources 11. It is noted that the number of the laser light sources 11 may be varied according to the practical requirements.

In this embodiment, the laser light source 11 emits a first light beam 100 with a first wavelength. The first light beam 100 is directed to the wavelength conversion element 12 through the relay lens group 151. By the wavelength conversion element 12, the first light beam 100 is converted into a light beam 101 according to a Lambertian's cosine law. The wavelength of the light beam 101 is different from the first wavelength of the first light beam 100. In some embodiments, the wavelength conversion element 12 is a static optical element or a rotatable optical element containing at least one phosphor powder. An example of the wavelength conversion element 12 includes but is not limited to a monochromatic phosphor wheel or a polychromatic phosphor wheel. In case that the wavelength conversion element 12 is a monochromatic phosphor wheel, the light beam 101 outputted from the wavelength conversion element 12 has a second wavelength. Whereas, in case that the wavelength conversion element 12 is a polychromatic phosphor wheel, the light beam 101 outputted from the wavelength conversion element 12 has a plurality of wavelengths (e.g. a second wavelength, a third wavelength and a fourth wavelength). In other words, the wavelength of the light beam 101 may be adjusted according to the type of the wavelength conversion element 12.

Please refer to FIG. 1 again. After the first light beam 100 with the first wavelength is converted into the light beam 101 with a wavelength different from the first wavelength by the wavelength conversion element 12, the light beam 101 is continuously processed by the relay lens group 152, the light homogenization set 16 and another relay lens group 153. Consequently, the optical path of the light beam 101 is converged, diverged or changed. Then, the light beam 101 is projected onto the projection lens 18 through the display module 17. Finally, an image beam is outputted from the projection lens 18. The architecture and the systematic optical path of the projection system 1 with the laser light source module 10 have been described as above.

An example of the display module 17 includes but is not limited to a liquid crystal display (LCD), a liquid crystal on silicon (LCoS) or a digital micro-mirror display (DMD). The examples of the display module 17 are well known to those skilled in the art, and are not redundantly described herein.

Moreover, the light detecting unit 13 and the controller 14 are electrically connected with each other. The light detecting unit 13 and the controller 14 are used for continuously monitoring the brightness and color of the light beam from the laser light source 11 without influencing the systematic optical path.

Please refer to FIG. 1 again. Preferably, the light detecting unit 13 of the projection system 1 is located beside the wavelength conversion element 12, but it is not limited thereto. That is, the light detecting unit 13 is not arranged in the optical path of the light beam 101. The light detecting unit 13 is used for detecting the optical energy which is outputted from the wavelength conversion element 12 and higher than the systematic etendue of the projection system 1 and transmitting the detecting result to the controller 14. According to the detecting result transmitted from the light detecting unit 13, the controller 14 will control the output power of the laser light source 11. Consequently, at least one of the brightness and the light color of the projection system 1 can be correspondingly adjusted or compensated.

In this embodiment, the light detecting unit 13 is located at a sensing area, which is defined by an included angle θ₄ between the light beam 101 and the wavelength conversion element 12. Consequently, the optical sensor 131 of the light detecting unit 13 can detect the optical energy of the sensing area without hindering the optical path of the light beam 101. According to the optical energy of the sensing area, the light intensity of the light beam 101 from the wavelength conversion element 12 can be acquired. In case that the light intensity of the light beam 101 attenuates or the brightness and color temperature need to be changed, the controller 14 may control the output power of the laser light source 11 according to the detecting result. Consequently, the brightness and the light color of the overall projection system 1 can be correspondingly adjusted.

The included angle θ₄ can be obtained according to an etendue conservation theorem. A method of obtaining the included angle θ₄ will be illustrated in more details as follows.

According to the etendue conservation theorem, the etendue can be expressed by the formula:

E=Nₒ²∫∫dAd cos θdΩ.

After the first light beam 100 with the first wavelength is converted into the light beam 101 with a wavelength different from the first wavelength by the wavelength conversion element 12, if the light beam 101 is uniformly projected according to the Lambertian's cosine law, the above formula may be simplified by the following formula:

E=πA sin²θ=π4/4(f#)².

Due to the area of the display module 17 and the incidence angle of the effective light beam (i.e. the light beam 101) relative to the display module 17, the effective etendue of the display module 17 may be expressed by the formula:

E₁=πAₚₐₙₑₗsin²θ₁.

While the first light beam 100 with the first wavelength is converted into the light beam 101 with a wavelength different from the first wavelength by the wavelength conversion element 12, the divergence angle is exhibited by the Lambertian's cosine law. Consequently, the etendue of the wavelength conversion element 12 may be expressed by the following formula:

E₂=πA_{EmittingSpotSize} sin²θ₂, θ₂=90°.

In practical, the etendue E2 is higher than the etendue E1. That is, the etendue E2 is higher than a systematic etendue E3. The etendue difference (E2−E3) between the etendue E2 and systematic etendue E3 cannot be effectively used by the display module 17, and may be considered as an ineffective etendue. The systematic etendue E3 may be expressed by the following formula:

E₃=πA_{EmittingSpotSize} sin²θ₃=E₁=πAₚₐₙₑₗ sin θ₁, θ₃<90°.

In addition, the relationship between the angles θ₂, θ₃ and θ₄ can be defined and expressed by the following formula: θ₂−θ₃=θ₄.

According to the etendue conservation theorem, the included angle θ₄ between the light beam 101 and the wavelength conversion element 12 is obtained. Moreover, the included angle θ₄ is related to the effective etendue of the display module 17. Since the light detecting unit 13 is located at the sensing area corresponding to the included angle θ₄, the optical energy of the sensing area can be detected by the light detecting unit 13 without hindering the optical path of the light beam 101 and the energy loss can be prevented. The light detecting unit 13 is used for detecting the optical energy which is outputted from the wavelength conversion element 12 and higher than the systematic etendue of the projection system 1. According to the detecting result, the controller 14 will control the output power of the laser light source 11. Consequently, the brightness and the light color of the projection system 1 can be correspondingly adjusted.

The projection system 1 of the present invention may have various aspects. For example, the projection system 1 may be a transmission-type projection system, a reflective-type projection system, a single-chip projection system or a three-chip projection system. According to the type of the projection system 1, the configuration of the laser light source module is correspondingly modified. Hereinafter, some exemplary laser light source module for different types of projection systems will be illustrated in more details.

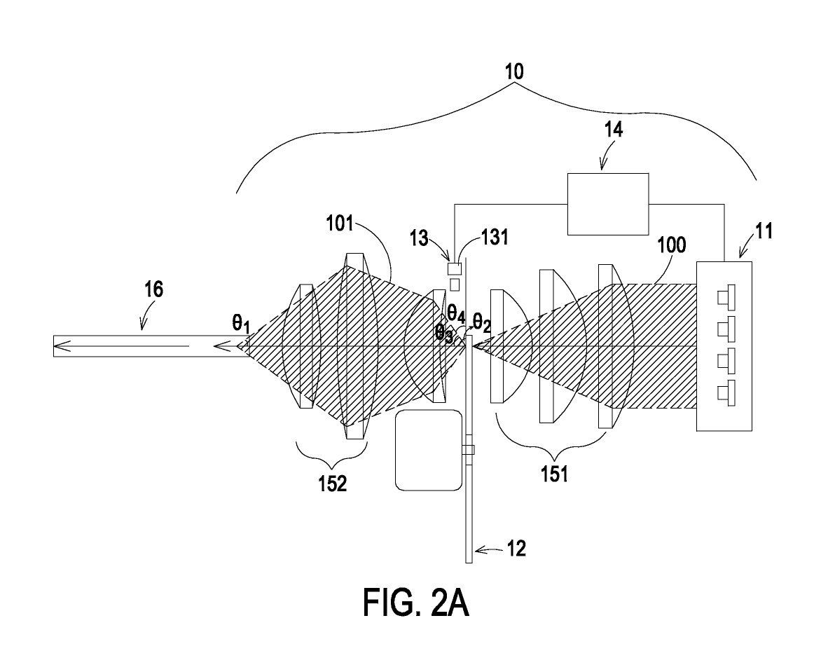

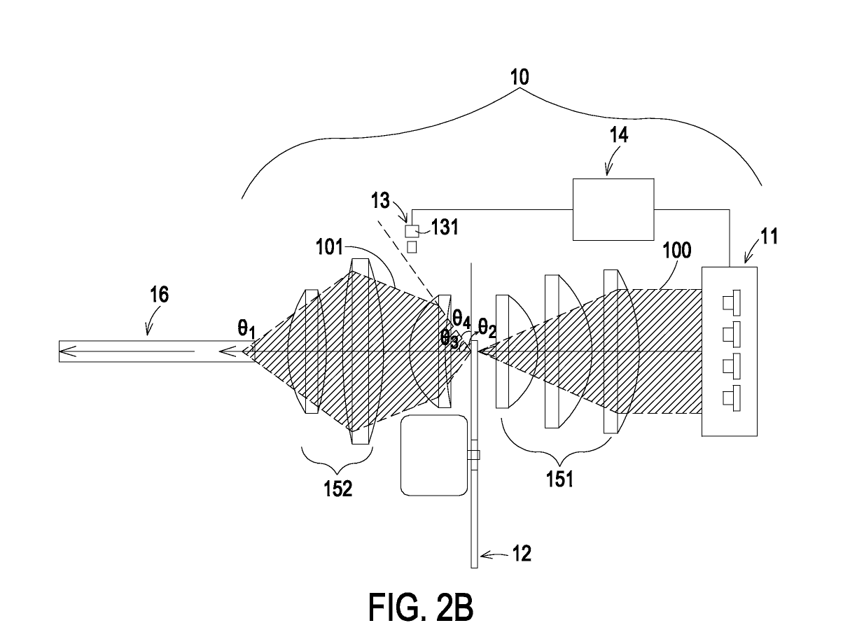

FIG. 2A schematically illustrates an exemplary laser light source module used in the transmission-type projection system according to the first embodiment of the present invention. In this embodiment, the projection system 1 is a transmission-type projection system. Correspondingly, the wavelength conversion element 12 is a transmission-type wavelength conversion element. The laser light source 11 emits a first light beam 100 with a first wavelength. The first light beam 100 is directed to the wavelength conversion element 12 through the relay lens group 151. By the relay lens group 151, the first light beam 100 is converted into a light beam 101, wherein the wavelength of the light beam 101 is different from the first wavelength. The light beam 101 is continuously processed by the relay lens group 152 and the light homogenization set 16. Preferably, the light detecting unit 13 is located beside the wavelength conversion element 12. Alternatively, as shown in FIG. 2B, the light detecting unit 13 is located beside the relay lens group 152. In addition, the light detecting unit 13 has an optical sensor 131 for detecting the optical energy of the sensing area, which is defined by an included angle θ₄ between the light beam 101 and the wavelength conversion element 12. According to the optical energy of the sensing area, the controller 14 can evaluate whether the light intensity of the laser light source 11 attenuates or the brightness and color temperature need to be changed. According to the evaluating result, the controller 14 will adjust the systematic brightness and color temperature of the laser light source 11.

In the laser light source module 10, each of the relay lens groups 151 and 152 is composed of plural lenses, but is not limited thereto. The relay lens groups 151 and 152 are used for converging, diverging or changing the optical paths of the light beams 100 and 101. The optical elements of the relay lens groups 151 and 152 are well known to those skilled in the art, and are not redundantly described herein. In this embodiment, the light detecting unit 13 comprises the optical sensor 131. Moreover, the light detecting unit 13 may further comprise an attenuator, a filter, an integral element and/or any other appropriate optical elements.

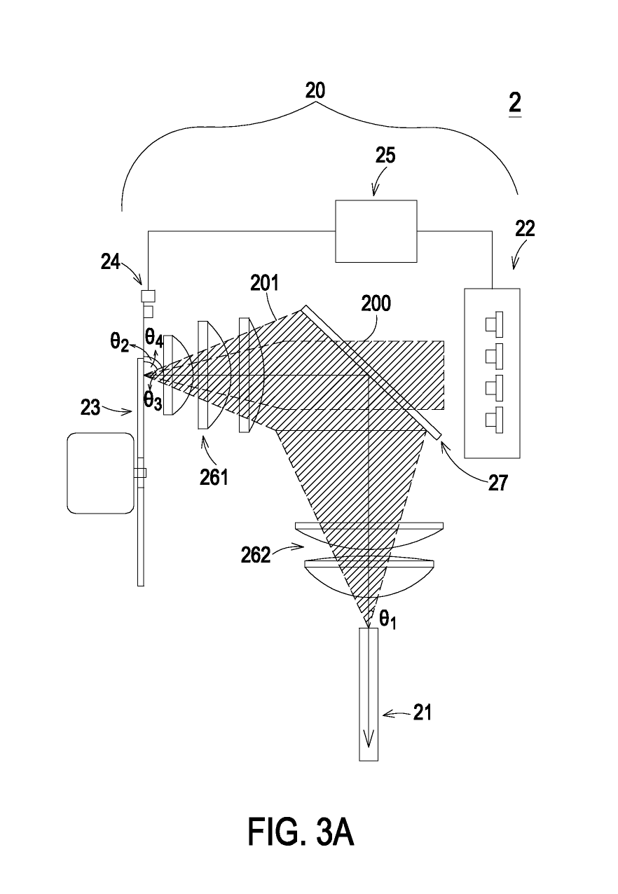

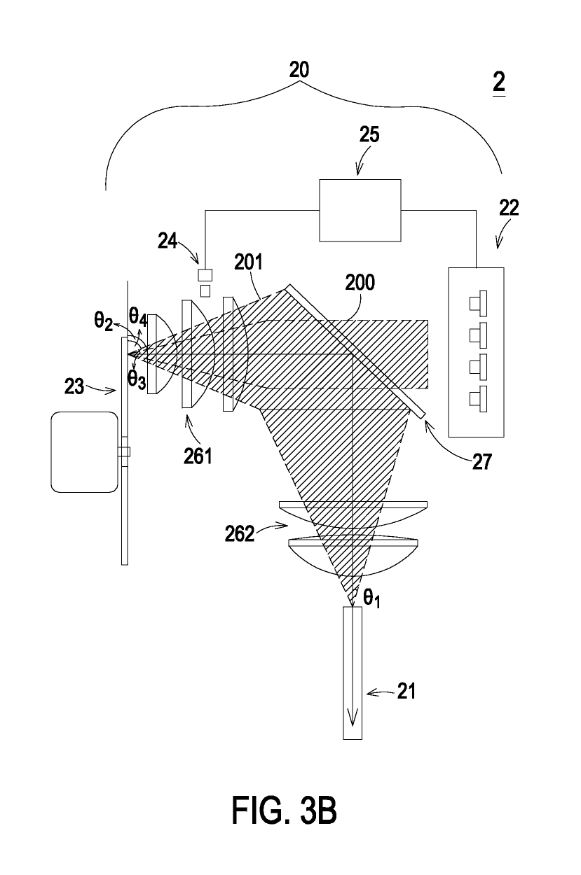

FIG. 3A schematically illustrates an exemplary laser light source module used in a reflective-type projection system according to a second embodiment of the present invention. In this embodiment, the projection system 2 is a reflective-type projection system. Similarly, the laser light source module 20 comprises a laser light source 22, a wavelength conversion element 23, a light detecting unit 24, a controller 25, two relay lens groups 261, 262, and a light homogenization set 21. Except for the following items, the structures of these components are similar to those of the laser light source module of the first embodiment, and are not redundantly described herein. In this embodiment, the wavelength conversion element 23 of the reflective-type projection system 2 is a reflective-type wavelength conversion element. In addition, the reflective-type projection system 2 further comprises a dichroic filter 27. The dichroic filter 27 is configured for allowing the first light beam 200 with the first wavelength to be transmitted through, and reflecting the light beam 201 outputted from the reflective-type wavelength conversion element 23. The laser light source 22 emits a first light beam 200 with a first wavelength. By the reflective-type wavelength conversion element 23, the first light beam 200 with the first wavelength is converted into a light beam 201 with a wavelength different from the first wavelength according to a Lambertian's cosine law. The first light beam 200 with the first wavelength is permitted to be transmitted through the dichroic filter 27. The light beam 201 may be reflected by the dichroic filter 27. In other words, the optical path of the light beam 201 may be adjusted by the dichroic filter 27. After the light beam 201 is reflected by the dichroic filter 27, the light beam 201 is directed to the light homogenization set 21 through the relay lens group 261. After the light beam 201 is outputted from the light homogenization set 21, the optical path of the light beam 201 is converged, diverged or changed. Then, the light beam 201 is processed by the display module (not shown), so that a modulated light beam is generated. The modulated light beam is projected as an image beam by a projection lens (not shown).

In this embodiment, the wavelength conversion element 23 of the reflective-type projection system 2 is a reflective-type wavelength conversion element. However, the structures and locations of the light detecting unit 24 are similar to those of the first embodiment. Preferably, the light detecting unit 24 is located beside the wavelength conversion element 23. Alternatively, as shown in FIG. 3B, the light detecting unit 24 is located beside the relay lens group 261. In this embodiment, the light detecting unit 24 is located at a sensing area, which is defined by an included angle θ₄ between the light beam 201 and the wavelength conversion element 23. Consequently, the light detecting unit 24 can detect the optical energy of the sensing area without hindering the optical path of the light beam 201. According to the optical energy of the sensing area, the light intensity of the light beam 201 from the wavelength conversion element 23 can be acquired. In case that the efficiency of the laser light source 22 or the wavelength conversion element 23 attenuates, the controller 25 may control the output power of the laser light source 22 according to the detecting result. Consequently, the brightness and the light color of the overall projection system 2 can be correspondingly adjusted.

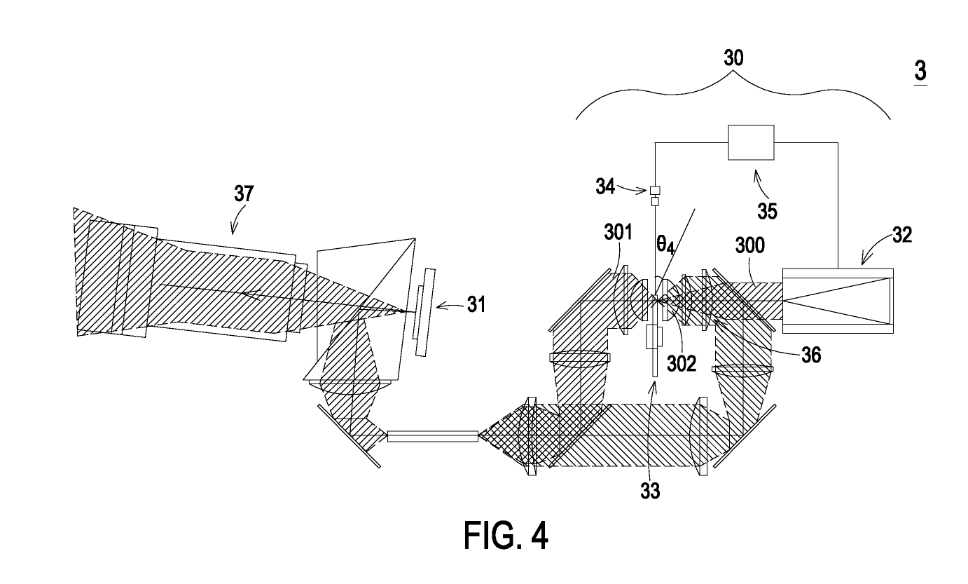

FIG. 4 schematically illustrates an exemplary laser light source module used in a single-chip projection system according to a third embodiment of the present invention. In this embodiment, the projection system 3 is a single-chip projection system. Similarly, the projection system 3 comprises a laser light source module 30, a display module 31, and a projection lens 37. The laser light source module 30 comprises a laser light source 32, a wavelength conversion element 33, a light detecting unit 34, a controller 35, and a relay lens group 36. The structures and functions of these optical elements are similar to those of the above embodiments, and are not redundantly described herein. Since the projection system 3 is a single-chip projection system, the projection system 3 has only a single display module 31. The laser light source 32 emits a first light beam 300 with a first wavelength. By the conversion element 33, the first light beam 300 with the first wavelength is converted into light beams 301 and 302 with wavelengths different from the first wavelength. Similarly, the optical paths of the light beams 301 and 302 are adjusted by plural relay lens groups and a light homogenization set. Then, the light beams 301 and 302 are processed by the single display module 31, so that a modulated light beam is generated. The modulated light beam is projected as an image beam by a projection lens (not shown).

By the wavelength conversion element 33, the first light beam 300 with the first wavelength is converted into the light beams 301 and 302 with different wavelengths. Preferably, the light detecting unit 34 of the projection system 3 is located beside the wavelength conversion element 33, but it is not limited thereto. The light detecting unit 34 is used for detecting the optical energy which is outputted from the wavelength conversion element 33 and higher than the systematic etendue of the projection system 3. That is, the light detecting unit 34 is used for detecting the optical energy at the sensing area, which is defined by the included angle θ₄. According to the detecting result, the controller 35 will control the output power of the laser light source 32. Consequently, at least one of the brightness and the light color of the laser light source module 30 can be correspondingly adjusted. Moreover, according to the output power of the laser light source 32, the systematic brightness and color temperature of the single-chip projection system 3 can be effectively adjusted.

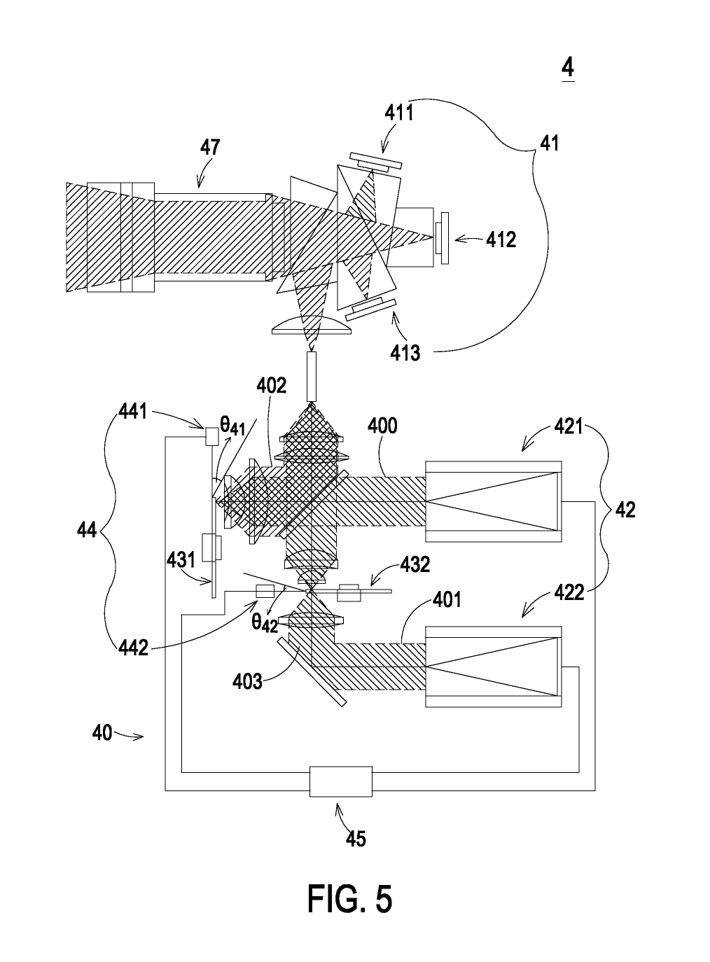

FIG. 5 schematically illustrates an exemplary laser light source module used in a three-chip projection system according to a fourth embodiment of the present invention. In this embodiment, the projection system 4 is a three-chip projection system. Similarly, the projection system 4 comprises a laser light source module 40, a display module 41, and a projection lens 47. Since the projection system 4 is a three-chip projection system, the projection system 4 comprises three display modules 411, 412 and 413. Moreover, a laser light source 42 of the laser light source module 40 comprises a first light source 421 and a second light source 422. The first light source 421 emits a light beam 400 with a first wavelength. By a first wavelength conversion element 431, the light beam 400 with the first wavelength is converted into a light beam 402 with a wavelength different from the first wavelength. Preferably, a first optical sensor 441 is located beside the first wavelength conversion element 431, but it is not limited thereto. The first optical sensor 441 is used for detecting the optical energy of the light beam 402 which is higher than the systematic etendue of the projection system 4. That is, the first optical sensor 441 is used for detecting the optical energy at the sensing area, which is defined by the included angle θ₄₁. The detecting result is transmitted to a controller 45. On the other hand, the second light source 422 emits a light beam 401 with a second wavelength. By a second wavelength conversion element 432, the light beam 401 with the second wavelength is converted into a light beam 403 with a wavelength different from the second wavelength. Preferably, a second optical sensor 442 is located beside the second wavelength conversion element 432, but it is not limited thereto. The second optical sensor 442 is used for detecting the optical energy of the light beam 403 which is higher than the systematic etendue of the projection system 4. That is, the second optical sensor 442 is used for detecting the optical energy at the sensing area, which is defined by the included angle θ₄₂. The detecting result is also transmitted to a controller 45. After the information from the light detecting unit 44 is received, the controller 45 will control the output powers of the first light source 421 and the second light source 422. Consequently, at least one of the brightness and the light color of the laser light source module 40 can be correspondingly adjusted. Moreover, after the light beams 402 and 403 outputted from the two wavelength conversion elements 431 and 432 are diverged, converged or reflected by the optical elements of the three-chip projection system 4, three light beams R, G and B with different wavelengths are directed to the display modules 411, 412 and 413, respectively. The light beams R, G and B are projected as an image beam by the projection lens 47.

In this embodiment, the first optical sensor 441 of the light detecting unit 44 is located at the sensing area defined by the included angle θ₄₁ between the light beam 402 and the first wavelength conversion element 431, and the second optical sensor 442 is located at the sensing area defined by the included angle θ₄₂ between the light beam 403 and the second wavelength conversion element 432. In addition, the included angles θ₄₁ and θ₄₂ are determined by the areas of the projection lens 47 and the display modules 41 and obtained according to the etendue conservation theorem.

In the above embodiments, the laser light source module of the present invention may be applied to a transmission-type projection system, a reflective-type projection system, a single-chip projection system or a three-chip projection system. The light detecting unit of the projection system is used for detecting the optical energy which is outputted from the wavelength conversion element and higher than the systematic etendue of the projection system. According to the detecting result, the controller will control the output power of the laser light source. Consequently, at least one of the brightness and the light color of the projection system can be correspondingly adjusted or compensated. Moreover, in case that the projection system comprises a plurality of laser light sources, the output powers of the plural laser light sources are controlled according to the detecting result. Consequently, the color temperature of the projection system is adjusted or the color temperature of the projection system becomes more stable.

From the above description, the present invention provides a laser light source module for a projection system. The laser light source module comprises a laser light source, a wavelength conversion element, and a light detecting unit. The laser light source is used for emitting a first light beam with a first wavelength. The wavelength conversion element for converting the first light beam into at least one light beam with a wavelength different from the first wavelength. The light detecting unit is used for detecting an optical energy which is outputted from the wavelength conversion element and higher than the systematic etendue of the projection system. The detecting result is transmitted to a controller. According to the detecting result, the output power of the laser light source is correspondingly controlled. Consequently, the brightness and the light color of the laser light projection system can be adjusted in real time. Moreover, in case that the efficiency of the laser light source or the wavelength conversion element attenuates, the controller may control the output power of the laser light source according to the detecting result. Consequently, the brightness and the light color of the overall projection system can be correspondingly adjusted or compensated. Moreover, since the light detecting unit is not arranged in the systematic optical path, the systematic optical path is not influenced by the light detecting unit. As a consequence, the laser light source module is capable of stabilizing the output brightness of the projection system and maintaining the color temperature of the projection system.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A projection system, comprising:
a laser light source module comprising:
at least one laser light source for emitting a first light beam with a first wavelength;
at least one wavelength conversion element for converting the first light beam into a light beam with a wavelength different from the first wavelength;
at least one light detecting unit comprising at least one optical sensor; and
a controller electrically connected with the light detecting unit;
at least one display module for receiving the light beam from the laser light source module, and outputting a modulated light beam; and
a projection lens for receiving the modulated light beam and projecting an image beam,
wherein after an optical energy of the light beam outputted from the wavelength conversion element and higher than a systematic etendue is detected by the optical sensor of the laser light source module, at least one of a brightness and a light color of the laser light source module is adjusted or compensated by the controller according to the detecting result.

2. The projection system according to claim 1, wherein the wavelength conversion element comprises at least one transmission-type wavelength conversion element or at least one reflective-type wavelength conversion element, wherein the wavelength conversion element is a static optical element or a rotatable optical element containing at least one phosphor powder.

3. The projection system according to claim 1, wherein the light detecting unit is located at a sensing area, which is defined by an included angle between the wavelength conversion element and the light beam outputted from the wavelength conversion element.

4. The projection system according to claim 3, wherein the included angle for defining the sensing area is determined according to an etendue conservation theorem, and the included angle is restricted by an effective etendue of the display module.

5. The projection system according to claim 1, wherein the at least one light detecting unit is located beside the wavelength conversion element.

6. The projection system according to claim 1, wherein the projection system is a single-chip projection system or a three-chip projection system.

7. The projection system according to claim 1, further comprising at least one relay lens group and a light homogenization set for converging, diverging and changing an optical path of the first light beam or the light beam outputted from the wavelength conversion element.

8. A laser light source module for a projection system, the laser light source module comprising:
at least one laser light source for emitting a first light beam with a first wavelength;
at least one wavelength conversion element for converting the first light beam into a light beam with a wavelength different from the first wavelength;
at least one light detecting unit comprising at least one optical sensor; and
a controller electrically connected with the light detecting unit,
wherein after an optical energy of the light beam outputted from the wavelength conversion element and higher than a systematic etendue is detected by the optical sensor, at least one of a brightness and a light color of the laser light source is adjusted or compensated by the controller according to the detecting result.

9. The laser light source module according to claim 8, wherein the wavelength conversion element comprises at least one transmission-type wavelength conversion element or at least one reflective-type wavelength conversion element, wherein the wavelength conversion element is a static optical element or a rotatable optical element containing at least one phosphor powder.

10. The laser light source module according to claim 8, wherein the light detecting unit is located at a sensing area, which is defined by an included angle between the wavelength conversion element and the light beam outputted from the wavelength conversion element.

11. The laser light source module according to claim 10, wherein the included angle for defining the sensing area is determined according to an etendue conservation theorem, and the included angle is restricted by an effective etendue of a display module of the projection system.

12. The laser light source module according to claim 8, wherein the at least one light detecting unit is located beside the wavelength conversion element.
